(19) United States
(12) Patent Application Publication
(10) Pub. No.: US 2009/0099852 A1
(43) Pub. Date: Apr. 16, 2009

(54) System and Method of Providing Data Subscription Services for Searchable Data Sources

(75) Inventor: Kenneth J. Ouimet, Scottsdale, AZ (US)

Correspondence Address: Robert D. Atkins, 605 W. Knox Road, Suite 104, Tampa, AZ, 85284, US

(73) Assignee: SAP AG, Walldorf (DE)

(21) Appl. No.: 11/869,909

(22) Filed: Oct. 10, 2007

(51) Int. Cl. G06Q 10/00

(52) U.S. Cl. 705/1

(57) ABSTRACT

A computer-implemented method involves offering data brokering services to clients. The client may be members of a supply chain needing to analyze statistical models. A data brokering platform is linked to a plurality of data sources. The data provided by the data sources is selected from demographic data, advertising data, product data, weather data, pricing data, sales data, shipping data, inventory data, and web spiders. A data portal interfaces with the data brokering platform for the client to search and retrieve data provided by the data sources. The data brokering services offers subscription management services, subscription management services, data distribution services, data rights services, and an adaptor for harmonizing data from multiple data sources. The data brokering platform is operated by a third-party service provider which offers models that utilize the data from the data brokering platform.

### CROSS-REFERENCE TO RELATED PATENT APPLICATIONS

The present patent application is related to copending U.S. patent application Ser. No. (Pending), Attorney Docket No. 114412.00012, entitled “System and Method of Facilitating Interaction Between Members of Supply Chain,” and filed concurrently herewith by Kenneth J. Ouimet.

### FIELD OF THE INVENTION

The present invention relates in general to statistical modeling and, more particularly, to a system and method of providing data subscription services for searchable data sources.

### BACKGROUND OF THE INVENTION

Retail stores are in business to sell merchandise and make a profit. Store managers are most concerned with product-related marketing and decisions such as product placement, assortment, space, price, promotion, and inventory. If the products are non-optimized in terms of these product decisions, then sales can be lost and profit will be less than what would otherwise be possible in an optimal system. For example, if the product assortment, space, or inventory is not properly selected or maintained, then the consumer is less likely to buy these products. If price is too high or too low, then profit can be lost. If promotions are not properly targeted, then marketing efforts will be wasted. If the product placement is poorly laid-out, then the store loses sales.

In a similar manner, suppliers (manufacturers and distributors) who supply to retail stores are in business to sell merchandise and make a profit. Suppliers are concerned with manufacturing, inventory, price, promotions, transportation, delivery schedules, returns, and seasonal merchandise. Yet, both retailers and suppliers share common concerns as they are inherently connected by supply chain logistics and economics. Problems at one end of the supply chain can adversely affect the profitability of another part of the supply chain. For example, if the supplier has not properly planned for inventory requirements for a promotional item, then the product may not be available to meet the retail demand or the supplier may be left with excess inventory at the end of the promotion. If the products sold by the suppliers are non-optimized in terms of their product decisions, then sales may be lost and profit will be less than what would otherwise be possible in an optimal system.

In order to maximize the outcome of product related decisions, retail store and supplier management have used statistical modeling and strategic planning to optimize the decision making process for many product decisions. Economic modeling and planning is commonly used to estimate or predict the performance and outcome of real systems, given specific sets of input data of interest. A model is a mathematical expression or representation that predicts the outcome or behavior of the system under a variety of conditions. An economic-based system will have many variables and influences which determine its behavior. In one sense, it is relatively easy to review historical data, understand its past performance, and state with relative certainty that the system's past behavior was indeed driven by the historical data. A much more difficult task, but one that is extremely important and valuable, is to generate a mathematical model of the system that predicts how the system will behave, or would have behaved, with different sets of data and assumptions. The field of probability and statistics has provided many tools that allow predictions to be made with reasonable certainty and acceptable levels of confidence.

In its basic form, the economic model can be viewed as a predicted or anticipated outcome of a mathematical expression, as driven by a given set of input data and assumptions. The input data is processed through the mathematical expression representing either the expected or current behavior of the real system. The mathematical expression is formulated or derived from principles of probability and statistics, often by analyzing historical data and corresponding known outcomes, to achieve an accurate correlation of the expected behavior of the system to other sets of data. In other words, the model should be able to predict the outcome or response of the system to a specific set of data being considered or proposed, within a level of confidence, or an acceptable level of uncertainty.

Economic modeling has many uses and applications. One emerging area in which modeling has exceptional promise is in the retail sales and supplier environments. Grocery stores, general merchandise stores, specialty shops, and other retail outlets face stiff competition for limited customers and business. Suppliers must manage the supply chain to service the retailers. Retailers and suppliers alike make every effort to maximize sales, volume, revenue, and profit. Economic modeling can be an effective tool in helping retail storeowners and suppliers achieve these important goals.

Businesses of all types are facing accelerating rates of change. New technologies, accelerating product life cycles, changes in consumer demand, and the competitive landscape are factors affecting business planning. Business intelligence and advanced statistical modeling and planning tools that are necessary to make well-informed and effective product decisions require timely access to reliable data. Yet, for many retailers and suppliers, the data for important product decisions must be pieced together from a variety of conflicting sources. A retailer that wants to conduct planning or ascertain its competitive position would have to determine which vendors can supply the necessary data, send out a request for proposal (RFP) for the data, evaluate the various submitted RFPs, select a vendor, access and analyze the quality of the data, and then harmonize the vendor data with other market data for use in the modeling or planning activity. The piece-meal data collection process is costly, labor intensive, and still fails to produce optimal planning. The process is long and arduous, sometimes taking weeks before the company can even start to analyze the data, which is too slow in fast moving markets. Making uninformed product decisions based-on untimely or unreliable data can be adverse to profitability and effective decision making.

A need exists for ready access to reliable data for use in making well-informed product decisions.

### SUMMARY OF THE INVENTION

In one embodiment, the present invention is a computer-implemented method of offering data brokering services to clients comprising the steps of providing a data brokering platform, linking a plurality of data sources to the data brokering platform, and providing a data portal to the data brokering platform for the client to search and retrieve data provided by the data sources.

In another embodiment, the present invention is a computer-implemented method of offering data subscription services comprising the steps of providing subscription data from a plurality of data sources, providing a data portal for a client to search and retrieve the subscription data provided by the data sources, and formatting the subscription data for use by the client.

In another embodiment, the present invention is a computer program product usable with a programmable computer processor having a computer readable program code which provides for subscription data from a plurality of data sources, provides a data portal for a client to search and retrieve the subscription data provided by the data sources, and formats the subscription data for use by the client.

In another embodiment, the present invention is a computer system for facilitating communication between members of a supply chain comprising means for providing subscription data from a plurality of data sources, means for providing a data portal for a client to search and retrieve the subscription data provided by the data sources, and means for formatting the subscription data for use by the client.

### BRIEF DESCRIPTION OF THE DRAWINGS

FIG. 1 is a block diagram of a supply chain interacting with a service provider of models and data;

FIG. 2 illustrates a process for product planning, modeling, and forecasting;

FIG. 3 illustrates a data brokering platform interacting between a client and data sources;

FIG. 4 is a data portal for the client to access subscription data through the data brokering platform;

FIG. 5 is a computer system for executing the data brokering services between the client and data sources; and

FIG. 6 illustrates the steps of providing the data brokering services between the client and data sources.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

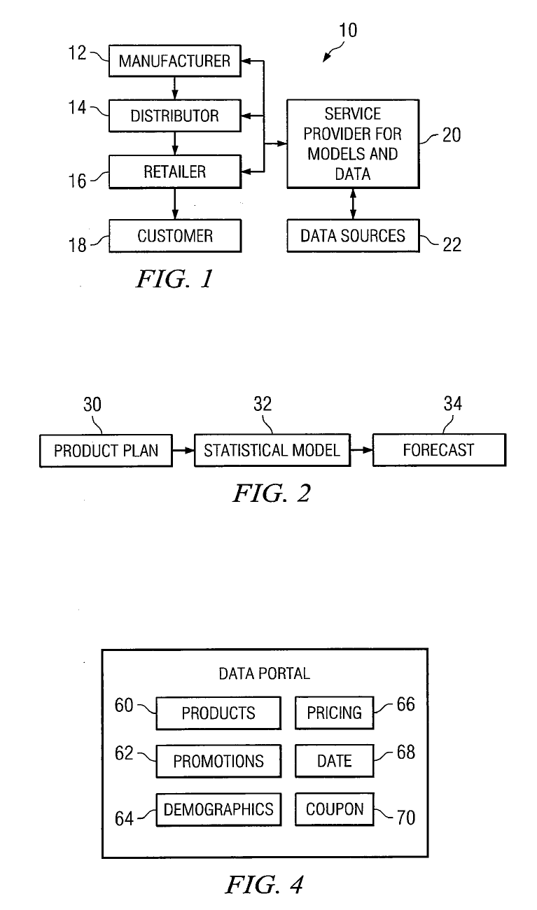

Referring to FIG. 1, in supply chain process 10, manufacturer 12 produces certain product lines or services. Distributor 14 buys from manufacturer 12 and sells to retail store (retailer) 16. Distributor 14 includes all levels of supply chain participants residing between the manufacturer and retailer who are involved in distribution and delivery of products. Manufacturer 12 and distributor 14 can each be viewed as a supplier depending on the frame of reference. Retailer 16 offers the product lines or services as available for sale to consumers 18. The terms products and services are used interchangeably in the present discussion. Retailer 16 may be a food store chain, general products retailer, drug store, clothing store, discount warehouse, department store, specialty store, etc. A store may be a single location, or a chain or logical group of stores.

Each member of the supply chain controls its respective product decisions. For example, manufacturer 12 controls manufacturing, promotions, delivery, and pricing of its products. Distributor 14 controls inventory, delivery, and pricing of its products. Retailer 16 has the ability to set pricing, order inventory, run promotions, arrange its product displays, collect and maintain historical sales data, and adjust its strategic business plan. Consumer 18 makes buying decisions based on quality, price, promotion, service, and value. The management teams of each supply chain member are held accountable for market share, profits, and overall success and growth of the business. The economic modeling tools and data processing system described herein are applicable to other enterprises and businesses having similar goals, constraints, and needs.

Manufacturer 12, distributor 14, and retailer 16 each have a business or operational plan. The business plan includes many planning, analyzing, and decision-making steps and operations. The business plan allows the management team to evaluate performance and trends, make strategic decisions, set pricing, alter manufacturing schedules, purchase equipment, order inventory, formulate and run promotions, hire employees, expand stores, add and remove product lines, organize product shelving and displays, select signage, and the like. The business plan provides the ability to analyze data, evaluate alternatives, run forecasts, and make operational decisions. The management team can change the business plan as necessary.

As one important tool for successful execution on its business plan, the management team needs accurate economic models. Economic and financial modeling has many uses and applications; it is an important business tool that allows companies to conduct business planning, forecast demand, manage supply chains, order equipment, control inventory, manage manufacturing, predict revenue, and optimize price and profit. Economic modeling is an effective tool in helping supply chain members achieve these goals.

From its business plan, each supply chain member provides certain observable data and assumptions to an enterprise model. The enterprise model includes the concept of economic models, as well as process, placement, assortment, pricing, manufacturing, distribution, scheduling, inventory, optimization, supply, demand, and other decision-based modeling. The model performs a series of complex calculations and mathematical operations to predict and forecast the business functions in which the user is most interested. For example, retailer 16 may run price optimizations for various promotional items based on its demand models and product data collected at the point of sale. Likewise, manufacturer 12 and distributor 14 can run optimizations on product decisions in support of retailer 16. Manufacturer 12, distributor 14, and retailer 16 each generate forecasts and predictions, usually in graphic form to aid in understanding their individual impact, as well as effects on other members to the supply chain. The output of the model is a report, graph, chart, table, or other analysis, which represents the model's forecasts and predictions based on the model parameters and the given set of data and assumptions. The forecast allows each supply chain member to make operational decisions.

FIG. 2 illustrates an analysis scenario which can be executed by each member of the supply chain. In block 30, a proposed product plan is formulated by a supply chain member to achieve a specific product-related goal, e.g., increases sales and profit. The product plan sets forth a set of data fields, including store, time period, price, promotion, assortment, cost of item, etc., which supports the criteria and rationale under which the plan will be executed. The supply chain member formulates the product plan by identifying or quantifying each data field. The proposed product plan is then evaluated through statistical model 32 to generate forecast 34.

Model 32 analyzes the data to predict price elasticity, promotional lift, seasonality, product life cycle and cannibalization under the product plan. One or more models can be used, depending on the product decision to be evaluated. In one embodiment, the statistical model is a demand model with coefficients or multipliers applied to non-linear functions that, through analysis of the shared data, quantify price elasticity, promotional lift, seasonality, product life cycle and cannibalization for the segment and product of interest. The demand model enables the planning application to forecast the impacts due to changes in price, promotion, and assortment. One demand model is disclosed in U.S. patent application Ser. No. 10/862,106, entitled “System and Method for Modeling Customer Response using Data Observable from Customer Buying Decisions,” which is hereby incorporated by reference. Another demand model is disclosed in U.S. patent application Ser. No. 11/064,874, entitled “System and Method for Modeling Non-Stationary Time Series using a Non-Parametric Demand Profile,” which is hereby incorporated by reference. Yet another demand model which simultaneously resolves multiple product decisions is disclosed in U.S. patent application Ser. No. 11/468,266, entitled, “System and Method of Modeling and Optimizing Product Parameters from Hierarchical Structure,” which is hereby incorporated by reference.

Demand models are used by advanced planning applications hosted by the client and are generated from points-of-sale data coupled with marketing, merchandising and promotional data. Demand models support multiple retail advanced planning applications, i.e., price, promotion, markdown, zone, assortment and space optimization, as well as forecasting and replenishment. Demand models support multiple supplier advanced planning applications such as trade promotion management, brand management, account management, category management, direct store delivery, and forecasting and replenishment. Demand models consist of coefficients that quantify each product's price elasticity, promotional lift, seasonality, product life cycle and cannibalization for the segment of interest. Used in planning applications, demand models enable the planning application to forecast the impacts due to changes in price, promotion and assortment. At the lowest level, demand models are built at the SKU-store-customer segment level and can be built at any aggregation of stores and customer segments. Model quality, in terms of forecast and parameter accuracy, is important to provide an automated, scalable solution that does not sacrifice model quality. Demand models can be scheduled at frequencies determined by the client. Each category can be modeled at a different frequency. Once approved, demand models are posed to the client's advanced planning applications.

Consider an example where manufacturer 12 has excess inventory of product P and formulates a plan using its data that includes a temporary price reduction for that product. The plan further includes expansion of highly visible displays of the product in the store. Manufacturer 12 formulates plan 30 for product P and executes demand model 32 to generate forecast 34. Forecast 34 is presented in a report format to project demand based on the proposed product plan.

The model advances planning applications between supply chain members as all require demand models to simulate, forecast, and optimize. Manufacturer 12 advanced planning applications include business intelligence, account/category management, retail advanced planning with a supplier perspective, trade promotion optimization, market mix optimization, and forecasting and replenishment. Retailer 16 advanced planning applications include business intelligence, price optimization, promotional optimization, markdown optimization, assortment and space optimization, forecasting and replenishment. The financial performance forecast accuracy and level of automation of advanced planning applications are dependent on the quality of the data as applied to the model.

It is important to provide ready access to reliable data for use in making well-informed product decisions and other business planning activities. Service provider 20 provides data brokering services to buy and sell data for this purpose. The data brokering service allows members of the supply chain to buy and sell data in transactions with selected parties. The member can price its demand content by type, segment, level of aggregation, and update frequency for each purchasing segment. In addition, each member of the supply chain can buy data from other members, as well as other data sources.

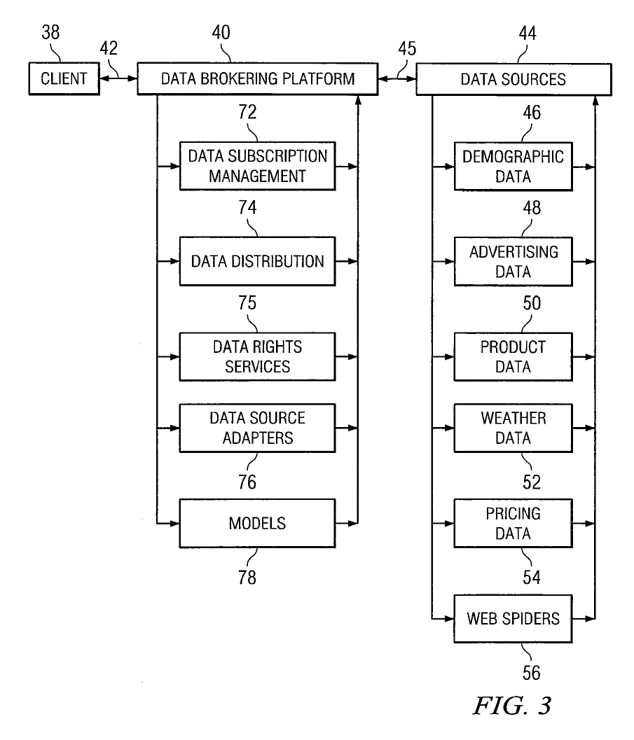

FIG. 3 illustrates a data brokering platform 40 in which service provider 20 makes data portals available for client 38, including supply chain members, to subscribe, search, and retrieve data. Data brokering platform 40 is applicable to any individual or business, i.e., the client, needing access to a variety of data sources. In other examples, the financial industry needs access to a number of data sources for its business planning. Research institutions rely on many different data sources for its operations. Governments utilize data sources for the public interest. The data portal represented by link 42 allows client 38 to search, compare, and purchase data. The data brokering platform communicates with a host of data sources 44 through electronic communication link 45. The platform facilitate the buying and selling of electronic data by operating as a central searchable source of electronic data making it easy to find and provides the ability for client 38 buy and/or sell data. The platform controls access and pricing to data and manage digital rights and subscriptions. Service provider 20 makes arrangements with each data source 44 to offer data to its client 38 by subscription. Service provider 20, operating through data brokering platform 40, identifies data source vendors, negotiates contracts, integrates the data, provides quality control, and harmonizes the data from each data source 44 for use by client 38.

Data sources 44 represent any source of information. For example, the data is available from sources such as International Research Institute, Remote Data Service, CPI Data Services, Marks Coupon, ACN, Gladson, Acxiom, Planalytics, Trade Dimension, Google, Microsoft, Census Track, Tivo, Microsoft Media Center, Agentrics and 1Sync. Data sources 44 provide a complete picture of the market. Each data source 44 is searchable. Each data source 44 has its own update and distribution frequency depending on the third-party data source and client requirements. The data sources can be simply pass-through or aligned. Aligned data sources require a mapping to a common customer, location, time, and require quality control procedures to ensure accuracy and reliability of data, as well as consistency with other data. Alignment of data sources 44 centralizes the process and eliminates the need to perform alignment in each client 38.

Each data source 44 may have information related to demographic data shown by block 46, advertising data in block 47, product data in block 48, weather data in block 49, competitive pricing data in block 50, sales data in block 51, shipping data in block 52, inventory data in block 54, or web spiders in block 56, just to name a few. Accordingly, the data can be directed to supply side and/or demand side applications. The data may be collected and compiled by data brokering platform 40 and stored in a local database for ready access by client 38. Alternately, data brokering platform 40 may search data sources 44 with each request from client 38. In any case, data brokering platform 40 simplifies the process of finding and accessing data for the benefit of client 38. The service gives client 38 the ability to access reliable, quality data in a cost-effective manner, analyze the data according to its needs, and quickly respond to changing markets conditions. In addition, data brokering platform 40 allows data sources 44 to expand their markets, making data a consumable commodity. Service provider 20, as retailer of data, profits by marking up the cost of the data.

In practice, the data portal is an application program interface or website page in which client 38 can specify the search criteria and receive relevant, reliable data formatted for its model or application. Client 38 completes data subscription parameters, e.g., data of interest, frequency of updates, level of aggregation, data format, and billing information. Once the subscription process is complete, data portal 42 allows client 38 to search and retrieve the desired data, as shown in FIG. 4. For example, client 38 can specify products in block 60, promotions in block 62, demographics in block 64, competitive pricing in block 66, date range in block 68, and coupon data in block 70.

Consider an example where small retail outlets (client) may want to conduct competitive pricing analysis using data from large retail stores (data sources). For each product of interest, data brokering platform 40 collects the price from each data source. For a particular product, retail store S1 will have price P1, retail store S2 will have price P2, and so on. The pricing data reflects whether the price is based on promotion, seasonal swing, location, or other qualifying factor. The data is tabulated and presented to the client.

In another example, manufacturer 12 wants to develop a product plan and needs retail data for the analysis as described in FIG. 2. Manufacturer 12 subscribes to the data brokering services offered by service provider 20. Service provider 20 has retail data available for purchase by arrangements made with data sources 44. The data is organized through data brokering platform 40 for ready access, formatted as per the parameters specified by manufacturer 12. Manufacturer 12 then utilizes data portal 42 to search for and retrieve the data necessary for its product plan analysis. Manufacturer 12 saves time and cost in having a single interface to a variety of data sources. Since service provider 20 also provides the modeling tools to the manufacturer, the data can be harmonized from multiple data sources and still function with the manufacturer's modeling tools.

Data brokering platform 40 controls data subscription management in block 72. The data distribution component manages data subscriptions and the automatic delivery of data on a scheduled basis. Client 38 receives the data in the proper format to perform the necessary analysis and respond to changing market conditions.

Data brokering platform 40 controls distribution of the data in block 74. The data distribution component manages data subscriptions and the automatic delivery of data on a scheduled basis. Client 38 receives the data in the proper format to perform the necessary analysis and respond to changing market conditions.

Data brokering platform 40 controls digital data rights in block 75. The digital data rights component manages the license agreements for the data. The data brokering platform 40 provides a flexible way for data sources 44 to license their data specifying different pricing for different licensing agreements. Data rights licenses can be made for specific application(s) or for specific periods of time. By pre-arranging the license, the data is made available only to applications that are properly licensed. As an example, a client can make application for data rights by sending a request to the data subscription management in block 72 of FIG. 3. The data subscription management checks to see if the client is approved to use data being requested. If so, an alphanumeric decryption key is sent back to the client as authorization to read the encrypted data. The digital data rights component benefits data sources and clients alike as the data sources receive compensation for their data and client 38 has confidence that the use is authorized.

Data brokering platform 40 provides adaptors for data sources 44 to post to a data hub on a scheduled or on-demand basis in block 76. Data transfer hubs are described in U.S. patent application Ser. No. ______, Attorney Docket No. 114412.000012, entitled “System and Method of Facilitating Interaction Between Members of Supply Chain”, which is hereby incorporated by reference. The data source-specific adaptor automatically harmonizes the data with other data sources so that the client can immediately use the data once delivered in the desired model or application.

Service provider 20 provides the statistical models as described in FIG. 2 for use with the subscription data in block 78. The data brokering services provided by service provider 20 offer the client access to both statistical models and subscription data necessary to perform the market analysis and response to changing market conditions.

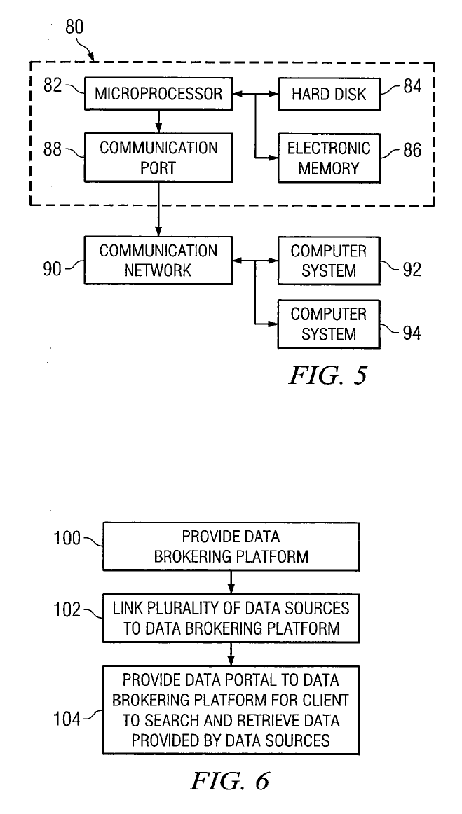

FIG. 5 illustrates a simplified computer system 80 for executing the software program used in the data brokering services. Computer system 80 is a general-purpose computer including a central processing unit or microprocessor 82, mass storage device or hard disk 84, electronic memory 86, and communication port 88. Communication port 88 represents a modem, high-speed Ethernet link, or other electronic connection to transmit and receive input/output (I/O) data with respect to other computer systems.

Computer 80 is shown connected to communication network 90 by way of communication port 88. Communication network 90 can be a local and secure communication network such as an Ethernet network, global secure network, or open architecture such as the Internet. Computer systems 92 and 94 can be configured as shown for computer 80 or dedicated and secure data terminals. Computers 92 and 94 are also connected to communication network 80. Computers 80, 92, and 94 transmit and receive information and data over communication network 90.

When used as a standalone unit, computer 80 can be located in any convenient location. When used as part of a computer network, computers 80, 92, and 94 can be physically located in any location with access to a modem or communication link to network 90. For example, computer 80 can be located in the main office of manufacturer 12, distributor 14, or retailer 16. Computer 92 can be located with data source 44. Computer 94 can be located with service provider 20. Alternatively, the computers can be mobile and accompany the users to any convenient location, e.g., remote offices, customer locations, hotel rooms, residences, vehicles, public places, or other locales with electronic access to communication network 90.

Each of the computers runs application software and computer programs which can be used to display user-interface screens, execute the functionality, and provide the features of the aforedescribed data brokering services. In one embodiment, the screens and functionality come from the application software, i.e., the system runs directly on one of the computer systems. Alternatively, the screens and functionality can be provided remotely from one or more websites on the Internet. The websites are generally restricted-access and require passwords or other authorization for accessibility. Communications through such websites may be encrypted using secure encryption algorithms. Alternatively, the screens and functionality are accessible only on the secure private network, such as Virtual Private Network (VPN), with proper authorization.

The software is originally provided on computer-readable media, such as compact disks (CDs), magnetic tape, or other mass storage medium. Alternatively, the software is downloaded from electronic links such as the host or vendor website. The software is installed onto the computer system hard drive 84 and/or electronic memory 86, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having a computer-readable program code embodied within the computer program product. The software contains one or more programming modules, subroutines, computer links, and compilations of executable code, which perform the functions of the data brokering services. The user interacts with the software via keyboard, mouse, voice recognition, and other user-interface devices connected to the computer system.

The software stores information and data related to the data brokering services in a database or file structure located on any one of, or combination of, hard drives 84 of the computers 80, 92, and/or 94. More generally, the information can be stored on any mass storage device accessible to computers 80, 92, and/or 94. The mass storage device may be part of a distributed computer system.

In the case of Internet-based websites, the interface screens are implemented as one or more webpages for receiving, viewing, and transmitting information related to the data brokering services. A host service provider may set up and administer the website from computer 80 located in the service provider's home office. The employee accesses the webpages from computers 92 and 94 via communication network 80.

As further explanation, FIG. 6 illustrates a process flowchart of one embodiment of the data brokering services. Step 100 provides a data brokering platform. In step 102, a plurality of data sources are linked to the data brokering platform. In step 104, a data portal to the data brokering platform offers the client the ability to search and retrieve data provided by the data sources. The data provided by the data sources is selected from demographic data, advertising data, product data, weather data, pricing data, and web spiders. The data brokering platform further providing subscription management services, data distribution services, data rights, and an adaptor for harmonizing data from multiple data sources. The data brokering platform is operated by a third-party service provider which offers models that utilize the data from the data brokering platform.

In summary, a service provider to a supply chain offers data brokering services. The data brokering services provide the client a one-stop shopping for data needed for market analysis and quick response to changing market conditions. The client need no longer assume the burden of finding data source(s), negotiating pricing, arranging for data rights, harmonizing the data from multiple sources, and formatting the data to function with the modeling tools. The data brokering platform will commoditize the sourcing, delivery, and harmonization of data. The client receives high quality, low cost business data which is essential for many business applications, e.g., retail demand forecast. The data sources benefit as the data brokering service provide an avenue to make the data a consumable commodity, which greatly increasing market space. The data sources have avenues to segment their markets and increase their sales and profits, while clients benefit by gaining access to reliable and cost-effective data. The data rights component ensures properly compensated and authorized use of the data. As a retailer of data, the service provider marks up the data for a profit. Since the service provider is also the model vendor, the data can be harmonized and formatted to be compatible with the models.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of offering data brokering services to clients, comprising:
providing a data brokering platform;
linking a plurality of data sources to the data brokering platform; and
providing a data portal to the data brokering platform for the client to search and retrieve data provided by the data sources.

2. The computer-implemented method of claim 1, wherein the data provided by the data sources is selected from the group consisting of demographic data, advertising data, product data, weather data, pricing data, sales data, shipping data, inventory data, and web spiders.

3. The computer-implemented method of claim 1, further including providing subscription management services through the data brokering platform.

4. The computer-implemented method of claim 1, further including providing data distribution services through the data brokering platform.

5. The computer-implemented method of claim 1, further including providing data rights through the data brokering platform.

6. The computer-implemented method of claim 1, further including providing an adaptor for harmonizing data from multiple data sources.

7. The computer-implemented method of claim 1, wherein the data brokering platform is operated by a third-party service provider which offers models that utilize the data from the data brokering platform.

8. A computer-implemented method of offering data subscription services, comprising:
providing subscription data from a plurality of data sources;
providing a data portal for a client to search and retrieve the subscription data provided by the data sources; and
formatting the subscription data for use by the client.

9. The computer-implemented method of claim 8, wherein the subscription data provided by the data sources is selected from the group consisting of demographic data, advertising data, product data, weather data, pricing data, sales data, shipping data, inventory data, and web spiders.

10. The computer-implemented method of claim 8, further including providing subscription management services for the client.

11. The computer-implemented method of claim 8, further including providing data distribution services for the client.

12. The computer-implemented method of claim 8, further including providing data rights for the client.

13. The computer-implemented method of claim 8, further including providing an adaptor for harmonizing the subscription data from multiple data sources.

14. The computer-implemented method of claim 8, wherein the data subscription is provided by a third-party service provider which offers models that utilize the subscription data from the data brokering platform.

15. A computer program product usable with a programmable computer processor having a computer readable program code embodied in the computer program product, comprising:
computer readable program code which provides for subscription data from a plurality of data sources;
computer readable program code which provides a data portal for a client to search and retrieve the subscription data provided by the data sources; and
computer readable program code which formats the subscription data for use by the client.

16. The computer program product of claim 15, wherein the subscription data provided by the data sources is selected from the group consisting of demographic data, advertising data, product data, weather data, pricing data, sales data, shipping data, inventory data, and web spiders.

17. The computer program product of claim 15, further including computer readable program code which provides subscription management services for the client.

18. The computer program product of claim 15, further including computer readable program code which provides data distribution services for the client.

19. The computer program product of claim 15, further including computer readable program code which provides data rights for the client.

20. The computer program product of claim 15, further including computer readable program code which provides an adaptor for harmonizing the subscription data from multiple data sources.

21. A computer system for facilitating communication between members of a supply chain, comprising:
means for providing subscription data from a plurality of data sources;
means for providing a data portal for a client to search and retrieve the subscription data provided by the data sources; and
means for formatting the subscription data for use by the client.

22. The computer system of claim 21, wherein the subscription data provided by the data sources is selected from the group consisting of demographic data, advertising data, product data, weather data, pricing data, sales data, shipping data, inventory data, and web spiders.

23. The computer system of claim 21, further including means for providing subscription management services for the client.

24. The computer system of claim 21, further including means for providing data distribution services for the client.

25. The computer system of claim 21, further including means for providing data rights for the client.
